(19) United States
(12) Patent Application Publication
(10) Pub. No.: US 2002/0122949 A1
(43) Pub. Date: Sep. 5, 2002

(54) Blackout and thermal drapery and drapery lining and method therefor

(76) Inventor: Jack J. Richards, Las Vegas, NV (US)

Correspondence Address: WEISS & MOY PC, 4204 NORTH BROWN AVENUE, SCOTTSDALE, AZ, 85251, US

(21) Appl. No.: 10/082,039

(22) Filed: Feb. 20, 2002

Related U.S. Application Data
(60) Provisional application No. 60/272,728, filed on Mar. 1, 2001.

(51) Int. Cl. B32B 15/08; B32B 27/00

(52) U.S. Cl. 428/462; 428/409

(57) ABSTRACT

A blackout and thermal drapery and drapery lining and method therefor having a metalized film which is capable of providing a barrier to light, heat and cold in an environmentally and ecologically sound way.

### RELATED APPLICATION

This application claims priority to a corresponding provisional application U.S. Serial No. 60/272,728, filed Mar. 1, 2001 in the name of the applicant of this application.

### FIELD OF THE INVENTION

This invention relates generally to draperies and drapery linings and, more specifically, to a blackout and thermal drapery and drapery lining and method therefor utilizing a metalized film and being capable of providing a barrier to light, heat and cold.

### BACKGROUND OF THE INVENTION

Conventional draperies are often designed for style and appearance, being made from various types of fabrics to create a desired visual effect. Such draperies, although providing a level of privacy, are generally not effective in preventing a substantial amount of light penetration into a room from outside sources. It is often the case, however, that certain people need to sleep during daylight hours, necessitating a drapery capable of blacking out natural light to create an atmosphere conducive to sleeping. Additionally, many people are interested in a blackout drapery in order to prevent outsiders from looking into their home.

For this purpose, several blackout draperies and blackout drapery linings have been created to deal with these problems. Many blackout draperies are in use both in residences as well as in the commercial hotel industry. To achieve the blackout effect, most blackout draperies are created by coating a drapery fabric with an acrylic latex coat that has been mixed with a black pigment, usually carbon black. Carbon black, however, represents a significant sink in the global carbon cycle, affects earth's radiative heat balance, is a carrier for organic pollutants, and is relatively resistant to degradation. Therefore, carbon black presents several serious environmental and ecological problems.

Additionally, by having an outer layer of acrylic latex, rather than a fabric, many current blackout draperies and drapery linings are more likely to wear after repeated cleanings. An outer layer of acrylic latex, as opposed to a fabric, also prevents the drapery from being printed on, dyed, or otherwise decorated.

Although current blackout draperies and blackout drapery linings do provide some thermal barrier effect, they are principally designed to be a barrier to light, not heat or cold. To also provide a thermal barrier effect, specially designed fabrics are currently used to provide this energy savings.

A need therefore existed for a blackout drapery and blackout drapery lining capable of achieving a blackout effect in an environmentally and ecologically sound way while at the same time providing a thermal barrier effect.

### SUMMARY OF THE INVENTION

An object of the present invention is to provide a blackout drapery having a metalized film capable of providing a blackout effect while at the same time creating a thermal barrier effect in a way that is both environmentally as well as ecologically sound.

It is a further object of the present invention to provide a blackout drapery lining having a metalized film capable of being coupled to a drapery fabric and providing a blackout effect while at the same time creating a thermal barrier effect in a way that is both environmentally an well as ecologically sound.

It is still a further object of the present invention to provide a method for manufacturing a blackout drapery having a metalized film capable of providing a blackout effect while at the same time creating a thermal barrier effect in a way that is both environmentally as well as ecologically sound.

It is yet a further object of the present invention to provide a method for manufacturing a blackout drapery lining having a metalized film capable of being coupled to a drapery fabric and providing a blackout effect while at the same time creating a thermal barrier effect in a way that is both environmentally as well as ecologically sound.

It is yet a further object of the present invention to provide a blackout and thermal barrier drapery having an outer layer of fabric which can be decorated.

It is yet a further object of the present invention to provide a blackout and thermal barrier drapery lining having an outer layer of fabric which can be decorated.

### BRIEF DESCRIPTION OF THE PREFERRED EMBODIMENTS

In accordance with one embodiment of the present invention, a blackout and thermal drapery lining is disclosed, comprising, in combination, a metalized film having a first side and a second side, a first layer of acrylic latex having a first side and a second side, the second side of the first layer of acrylic latex is coated to the first side of the metalized film, and a second layer of acrylic latex having a first side and a second side, the first side of the second layer of acrylic latex is coated to the second side of the metalized film.

In accordance with another embodiment of the present invention, a blackout and thermal drapery is disclosed, comprising, in combination, a metalized film having a first side and a second side, a fabric having a first side and a second side, the second side of the fabric is coupled to the first side of the metalized film, and a layer of acrylic latex having a first side and a second side, the first side of the layer of acrylic latex is coated to the second side of the metalized film.

In accordance with still another embodiment of the present invention, a blackout and thermal drapery is disclosed, comprising, in combination, a metalized film having a first side and a second side, a first layer of fabric having a first side and a second side, the second side of the first layer of fabric is coupled to the first side of the metalized film, and a second layer of fabric having a first side and a second side, the first side of the second layer of fabric is coupled to the second side of the metalized film.

In accordance with yet another embodiment of the present invention, a method for manufacturing a blackout and thermal drapery lining is disclosed, comprising, in combination, the steps of providing a film having a first side and a second side, metalizing the first side of the film and the second side of the film, coating a first layer of acrylic latex to the first side of the metalized film, and coating a second layer of acrylic latex to the second side of the metalized film.

In accordance with yet another embodiment of the present invention, a method for manufacturing a blackout and thermal drapery in disclosed, comprising, in combination, the steps of providing a film having a first side and a second side, metalizing the first side of the film and the second side of the film, providing a fabric having a first side and a second side, coupling the second side of the fabric to the first side of the metalized film, and coating a layer of acrylic latex to the second side of the metalized film.

In accordance with yet another embodiment of the present invention, a method for manufacturing a blackout and thermal drapery is disclosed, comprising, in combination, the steps of providing a film having a first side and a second side, metalizing the first side of the film and the second side of the film, providing a first layer of fabric having a first side and a second side, coupling the second side of the first layer of fabric to the first side of the metalized film, providing a second layer of fabric having a first side and a second side, and coupling the first side of the second layer of fabric to the second side of the metalized film.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective, partially exploded view of an embodiment of the blackout and thermal drapery lining of the present invention, showing the metalized film sandwiched between a first layer of acrylic latex and a second layer of acrylic latex.

FIG. 2 is a perspective, partially exploded view of one embodiment of the blackout and thermal drapery of the present invention, showing the metalized film sandwiched between a layer of fabric on one side and a layer of acrylic latex on the other side.

FIG. 3 is a perspective, partially exploded view of one embodiment of the blackout and thermal drapery of the present invention, showing the metalized film sandwiched between a first layer of fabric on one side and a second layer of fabric on the other side.

FIG. 4 is a perspective, partially exploded view of one embodiment of the blackout and thermal drapery of the present invention, showing the metalized film sandwiched between two layers of acrylic latex with a layer of fabric coupled to one of the layers of acrylic latex.

### DETAILED DESCRIPTION OF THE PREFERRED EMBODIMENTS

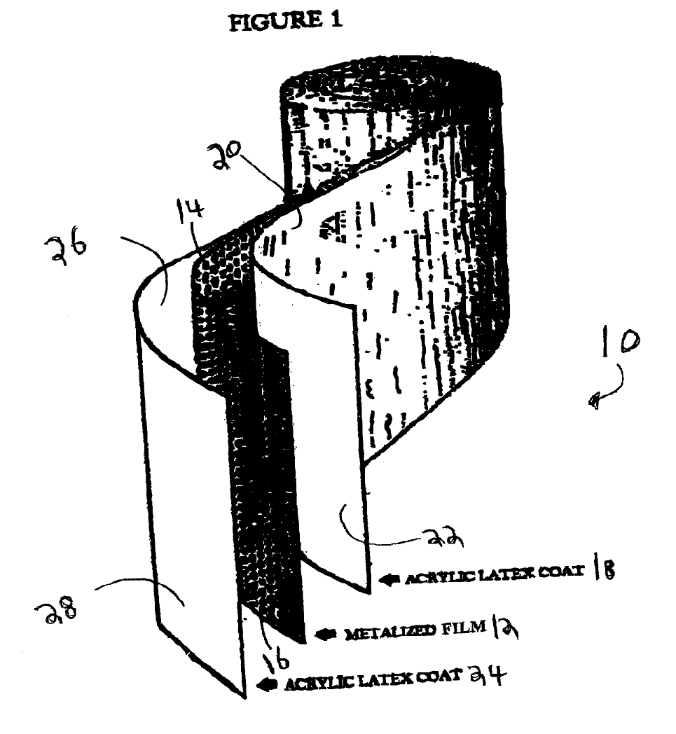

Referring to FIG. 1, one embodiment of the blackout and thermal drapery lining, hereinafter blackout and thermal drapery lining 10, is shown. The blackout and thermal drapery lining 10 is comprised of a metalized film 12 having a first side 14 and a second side 16.

Preferably, the film substrate of the metalized film 12 is comprised of polypropylene, although it should be clearly understood that substantial benefit could be derived from an alternative configuration of the blackout and thermal drapery lining 10 in which the film substrate of the metalized film 12 is comprised of an alternative substance other than polypropylene, such as polyester film, PVC film, polyurethane film, polyethylene film, or the like.

In the preferred embodiment, the metalized film 12 is metalized with aluminum, although it should be clearly understood that substantial benefit could be derived from an alternative configuration of the blackout and thermal drapery lining 10 in which the metalized film 12 is metalized with an aluminum alloy, titanium, tungsten, a combination thereof or blends of other metal components so long as the metalized film 12 is capable of being either light impermeable or a thermal barrier, or both.

Preferably, the aluminum or other metal used to metalize the metalized film 12 has an optical rating of between 1.5 and 4.0, although it should be clearly understood that substantial benefit could be derived from an alternative configuration of the blackout and thermal drapery lining 10 in which the optical rating of the aluminum or other metal deviates, even substantially, from the preferred optical rating in either direction.

In the preferred embodiment, the aluminum or other metal used to metalize the metalized film 12 has a thickness of between 0.0002 and 0.03 millimeters, although it should be clearly understood that substantial benefit could be derived from an alternative configuration of the blackout and thermal drapery lining 10 in which the thickness of the aluminum or other metal deviates, even substantially, from the preferred thickness in either direction.

The blackout and thermal drapery lining 10 further comprises a first layer of acrylic latex 18 having a first side 20 and a second side 22, although it should be understood that in addition to acrylic, urethanes or a blend of urethane and acrylic is also contemplated. The second side 22 of the first layer of acrylic latex 18 is coated to the first side 14 of the metalized film 12 The blackout and thermal drapery lining 10 further comprises a second layer of acrylic latex 24 having a first side 26 and a second side 28. The first side 26 of the second layer of acrylic latex 24 is coated to the second side 16 of the metalized film 12.

In one embodiment, the first side 20 of the first layer of acrylic latex 18 is flocked and the second side 28 of the second layer of acrylic latex 24 is flocked, although it should be clearly understood that substantial benefit could be derived from an alternative configuration of the blackout and thermal drapery lining 10 in which only the first side 20 of the first layer of acrylic latex 18 is flocked or only the second side 28 of the second layer of acrylic latex 24 is flocked, or neither layer of acrylic latex is flocked.

In one embodiment, the first side 20 of the first layer of acrylic latex 18 is flame retardant and the second side 29 of the second layer of acrylic latex 24 is flame retardant, although it should be clearly understood that substantial benefit could be derived from an alternative configuration of the blackout and thermal drapery lining 10 in which only the first side 20 of the first layer of acrylic latex 18 is flame retardant or only the second side 28 of the second layer of acrylic latex 24 is flame retardant, or neither layer of acrylic latex is flame retardant.

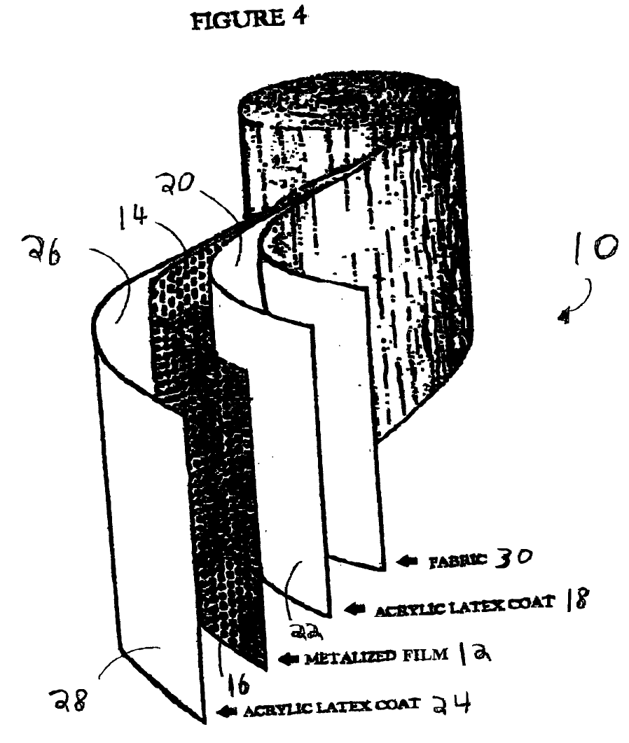

Referring now to FIG. 4, the blackout and thermal drapery lining 10 is dimensioned to be lined to a fabric 30 in order to create a blackout and thermal drapery. By coupling to a fabric 30 a blackout and thermal drapery lining 10 having two layers of acrylic latex, the fabric 30 can be printed on without any discoloration. In the preferred embodiment, the fabric 30 has a width of between 36 inches and 160 inches, although it should be clearly understood that substantial benefit could be derived from an alternative configuration of the blackout and thermal drapery lining 10 in which the width of the fabric deviates, even substantially from the preferred width, in either direction. The fabric 30 is coupled to the first side 20 of the first layer of acrylic latex 18, although it should be clearly understood that substantial benefit could be derived from an alternative configuration of the blackout and thermal drapery lining 10 in which the fabric 30 is instead coupled to the second side 28 of the second layer of acrylic latex 24.

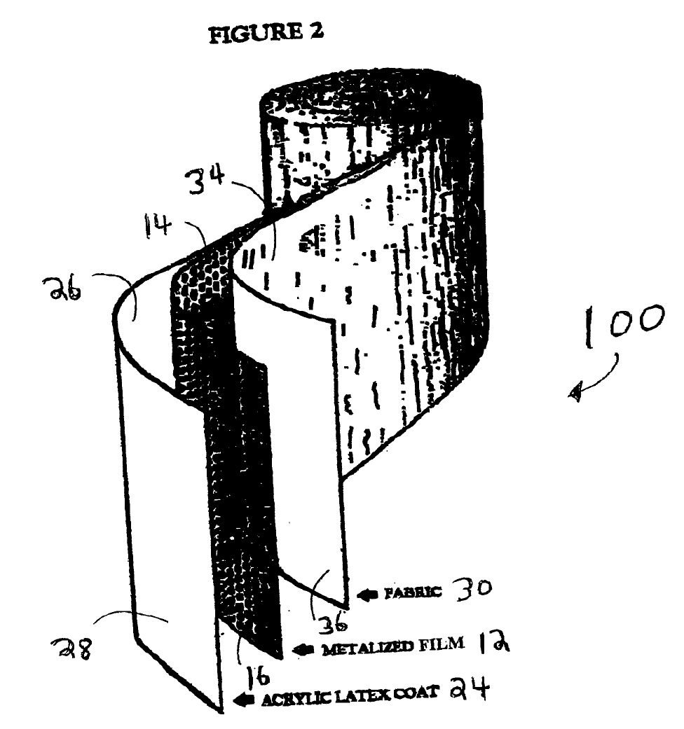

Referring now to FIG. 2, a blackout and thermal drapery, hereinafter blackout and thermal drapery 100 is disclosed. The blackout and thermal drapery 100 is substantially the same as the blackout and thermal drapery lining 10, except that in the blackout and thermal drapery 100 a fabric 30 replaces one of the layers of acrylic latex that is present in the blackout and thermal drapery lining 10, making the blackout and thermal drapery 100 a drapery, instead of a drapery lining. For this reason, the same reference numbers used in describing the features of the blackout and thermal drapery lining 10 will be used when describing the identical features of the blackout and thermal drapery 100. The blackout and thermal drapery 100 comprises a metalized film 12 having a first side 14 and a second side 16. The blackout and thermal drapery 100 comprises a fabric 30 having a first side 34 and a second side 36. The second side 36 of the fabric 30 is coupled to the first side 14 of the metalized film 12. The fabric 30 may be woven or non-woven. The blackout and thermal drapery 100 further comprises a layer of acrylic latex 24 having a first side 26 and a second side 28. The first side 26 is coated to the second side 16 of the metalized film 12.

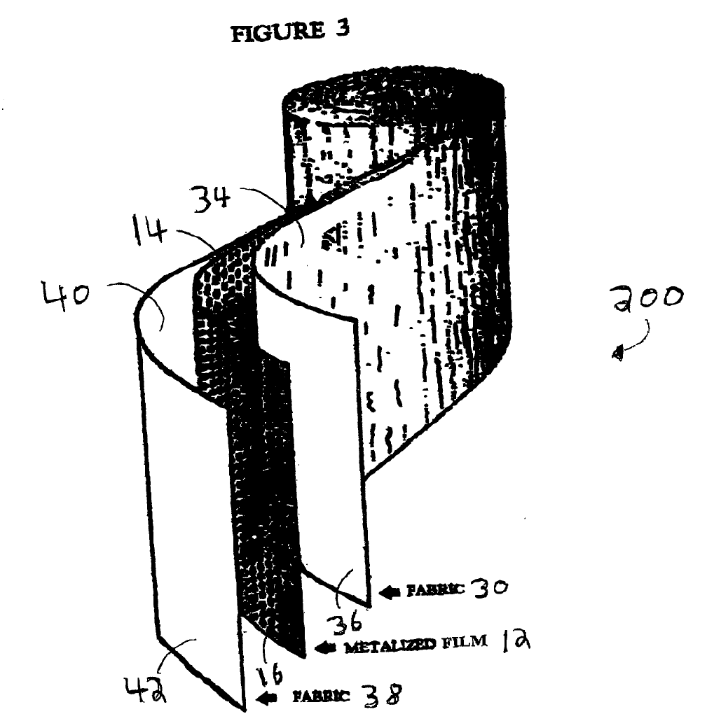

Referring now to FIG. 3, a blackout and thermal drapery, hereinafter blackout and thermal drapery 200 is disclosed. The blackout and thermal drapery 200 is substantially the same as the blackout and thermal drapery 100, except that in the blackout and thermal drapery 200 a second layer of fabric 38 replaces the layer of acrylic latex 24 that is present in the blackout and thermal drapery 100. For this reason, the same reference numbers used in describing the features of the blackout and thermal drapery 100 will be used when describing the identical features of the blackout and thermal drapery 200. The blackout and thermal drapery 200 comprises a metalized film 12 having a first side 14 and a second side 16. The blackout and thermal drapery 200 comprises a first layer of fabric 30 having a first side 34 and a second side 36. The second side 36 of the first layer of fabric 30 is coupled to the first side 14 of the metalized film 12. The blackout and thermal drapery 200 comprises a second layer of fabric 33 having a first aide 40 and a second side 42. The first side 40 of the second layer of fabric 38 is coupled to the second side 16 of the metalized film 12. The two layers of fabric in the blackout and thermal drapery 200 allows for both sides of a drapery to be decorated, as opposed to the blackout and thermal drapery 100 in which only the one fabric side of the drapery can be decorated.

While the invention has been particularly shown and described with reference to preferred embodiments thereof, it will be understood by those skilled in the art that the foregoing and other changes in form and details may be made therein without departing from the spirit and scope of the invention.

I claim:

1. A blackout and thermal drapery lining comprising, in combination;
a metalized film having a first side and a second side;
a first layer of acrylic latex having a first side and a second side, said second side of said first layer of acrylic latex is coated to said first side of said metalized film; and
a second layer of acrylic latex having a first side and a second side, said first side of said second layer of acrylic latex is coated to said second side of said metalized film.

2. The blackout and thermal drapery lining of claim 1 wherein said first side of said first layer of acrylic latex is flocked.

3. The blackout and thermal drapery lining of claim 1 wherein said second side of said second layer of acrylic latex is flocked.

4. The blackout and thermal drapery lining of claim 1 wherein said first side of said first layer of acrylic latex is flame retardant.

5. The blackout and thermal drapery lining of claim 1 wherein said second side of said second layer of acrylic latex is flame retardant.

6. The blackout and thermal drapery lining of claim 1 wherein said film is metalized with aluminum.

7. The blackout and thermal drapery lining of claim 6 wherein said aluminum has an optical rating of between 1.5 and 4.0.

8. The blackout and thermal drapery lining of claim 1 wherein said metalalized film is metalized with a metal having a thickness of between 0.0002 to 0.03 millimeters.

9. The blackout and thermal drapery lining of claim 1 wherein said film is polypropylene.

10. The blackout and thermal drapery lining of claim 1 further comprising a drapery fabric coupled to said first side of said first layer of acrylic latex.

11. A blackout and thermal drapery comprising, in combination:
metalized film having a first side and a second side;
a fabric having a first side and a second side, said second side of said fabric is coupled to said first side of said metalized film; and
a layer of acrylic latex having a first side and a second aide, said first side of said layer of acrylic latex is coated to said second side of said metalized film.

12. The blackout and thermal drapery of claim 11 wherein said second side of said layer of acrylic latex is flocked.

13. The blackout and thermal drapery of claim 11 wherein said second side of said layer of acrylic latex is flame retardant.

14. The blackout and thermal drapery of claim 11 wherein said metalized film is metalized with aluminum.

15. The blackout and thermal drapery of claim 14 wherein said aluminum has an optical rating of between 1.5 and 4.0.

16. The blackout and thermal drapery of claim 11 wherein said metalalized film is metalized with a metal having a thickness of between 0.0002 to 0.03 millimeters.

17. The blackout and thermal drapery of claim 11 wherein said film is polypropylene.

18. A blackout and thermal drapery comprising, in combination:
a metalized film having a first side and a second side;
a first layer of fabric having a first side and a second side, said second side of said first layer of fabric is coupled to said first side of said metalized film; and
a second layer or fabric having a first side and a second side, said first side of said second layer of fabric is coupled to said second side of said metalized film.

19. The blackout and thermal drapery of claim 19 wherein said metalized film is metalized with aluminum.

20. The blackout and thermal drapery of claim 19 wherein said aluminum has an optical rating of between 1.5 and 4.0.

21. The blackout and thermal drapery of claim 18 wherein said metalized film is metalized with a metal having a thickness of between 0.0002 to 0.03 millimeters.

22. The blackout and thermal drapery of claim 18 wherein said film is polypropylene.

23. A method for manufacturing a blackout and thermal drapery lining, comprising, in combination, the steps of:
providing a film having a first side and a second side;
metalizing said first side of said film and said second side of said film;
coating a first layer of acrylic latex to said first side of said metalized film; and
coating a second layer of acrylic latex to said second side of said metalized film.

24. The method of claim 23 further comprising the step of flocking said first layer of acrylic latex.

25. The method of claim 23 further comprising the step of flocking said second layer of acrylic latex.

26. The method of claim 23 further comprising the steps of:
providing a fabric; and
coupling said fabric to said first layer of acrylic latex.

27. A method for manufacturing a blackout and thermal drapery, comprising, in combination, the steps of:
providing a film having a first side and a second side;
metalizing said first side of said film and said second side of said film;
providing a fabric having a first side and a second side;
coupling said second side of said fabric to said first side of said metalized film; and
coating a layer of acrylic latex to said second side of said metalized film.

28. The method of claim 27 further comprising the step of flocking said layer of acrylic latex.

29. A method for manufacturing a blackout and thermal drapery, comprising, in combination, the steps of:
providing a film having a first side and a second side;
metalizing said first side of said film and said second side of said film;
providing a first layer of fabric having a first side and a second side;
coupling said second side of said first layer of fabric to said first side of said metalized film;
providing a second layer of fabric having a first side and a second side; and
coupling said first side of said second layer of fabric to said second side of said metalized film.
